(19) United States
(12) Patent Application Publication
(10) Pub. No.: US 2014/0098385 A1
(43) Pub. Date: Apr. 10, 2014

(54) PRINTING APPARATUS AND PRINTING METHOD

(71) Applicant: Seiko Epson Corporation, Shinjuku-ku (JP)

(72) Inventors: Hironori ENDO, Okaya-shi (JP); Toshihisa Saruta, Matsumoto-shi (JP); Toru Matsuyama, Matsumoto-shi (JP)

(73) Assignee: Seiko Epson Corporation, Shinjuku-ku (JP)

(21) Appl. No.: 14/051,415

(22) Filed: Oct. 10, 2013

(30) Foreign Application Priority Data
Oct. 10, 2012 (JP) 2012-224649

(51) Int. Cl. G06K 15/02

(52) U.S. Cl. CPC G06K 15/1872
USPC 358/1.2

(57) ABSTRACT

The printing apparatus includes a reference drive signal generation section that generates a reference drive signal, a signal modulation section that modulates the reference drive signal to generate a modulation reference drive signal, a signal amplification section that amplifies the modulation reference drive signal using switching elements to generate a modulation drive signal, a signal conversion section that converts the modulation drive signal to a drive signal, a piezoelectric element that deforms in response to the drive signal, a pressure chamber that expands or contracts due to the deformation of the piezoelectric element, a nozzle opening portion that communicates with the pressure chamber, and a frequency control section which limits a switching frequency to be less than a predetermined value in a case where a product of the printing resolution and the printing speed is equal to or larger than a threshold value.

### BACKGROUND

1. Technical Field

The present invention relates to a printing apparatus and a printing method.

2. Related Art

A printing apparatus of an ink jet type is widely used, which ejects ink on a print medium from a plurality of nozzles provided in a print head so as to record text and images. In such a printing apparatus, a predetermined amount of ink is ejected from the nozzles at a predetermined timing by piezoelectric elements, each of which is provided in a location corresponding to each nozzle of the print head, being driven in response to a drive signal.

For example, the drive signal is generated by the following procedure. A digital modulation reference drive signal is generated by pulse-modulating an analog reference drive signal using a Pulse Width Modulation (PWM) method, a Pulse Density Modulation (PDM) method, a Pulse Amplitude Modulation (PAM), or the like. Then, the modulation reference drive signal is amplified to generate a modulation drive signal, and the modulation drive signal is converted into a drive signal, which is an analog signal, by smoothing.

In the related art, a print head driving circuit capable of suppressing heat generation of switching elements as well as reducing power consumption by utilizing a capacitor has been known (for example, see JP-A-11-170529).

In recent years, a high speed printing is required in a printing apparatus, so that the number of ejections per unit time tends to increase for the sake of high speed printing. Further, a high quality and high resolution printing is required in the printing apparatus, so that the number of dots (number of pixels) per one sheet to be printed tends to increase, and the number of ejections per one sheet to be printed also tends to increase. User's need is a high speed and high quality printing in which the two above requirements are combined, and a user directly requires for an increase in the number of ejections per unit time in the printing device. In a case of realizing an increase in the number of ejections per unit time, the power consumed by a print head also increases in proportion to the number of ejections, so that there is a problem that power shortage occurs. In addition to the problem of power consumption, in proportion to the power consumption, heat generation resistance generated in the piezoelectric element and each circuit has also become a big problem. Heating destabilizes the operation of each circuit and the piezoelectric element, which would cause a deterioration of printing quality. As a result, a problem occurs that printed materials, not meeting basic requirements for “high quality”, are produced. In an amplifier (so called D-class amplifier) using a switching element in the related art, measures to reduce heating losses have been made for such problems. However, as the requirements for high speed and high image quality increase, the number of switching operations per unit time becomes excessively large, so that the problems of power consumption and heat generation may not be treated with the above measures.

### SUMMARY

The invention can be realized in the following forms.

1. According to a first aspect of the invention, there is provided a printing apparatus. The printing apparatus is capable of performing a printing with at least two printing resolutions which are a first resolution and a second resolution higher than the first resolution, and at least two printing speeds which are a first printing speed and a second printing speed faster than the first printing speed. The printing apparatus includes a reference drive signal generation section that generates a reference drive signal; a signal modulation section that modulates the reference drive signal to generate a modulation reference drive signal; a signal amplification section that amplifies the modulation reference drive signal using switching elements to generate a modulation drive signal; a signal conversion section that converts the modulation drive signal to a drive signal; a piezoelectric element that deforms in response to the drive signal; a pressure chamber that expands or contracts due to the deformation of the piezoelectric element; a nozzle opening portion that communicates with the pressure chamber; and a frequency control section which limits a switching frequency of the switching element to be less than a predetermined value in a first case where a product of the printing resolution and the printing speed is equal to or larger than a threshold value, and does not limit a switching frequency of the switching element to be less than a predetermined value in a second case where a product of the printing resolution and the printing speed is less than a threshold value. In this case, since the switching frequency of the switching element is limited to be less than the predetermined value in the first case where the product of the printing resolution and the printing speed is equal to or larger than the threshold value, it is possible to suppress an influence on an image quality and to avoid the occurrence of problems due to heat generation and increase in power consumption. Since the switching frequency of the switching element is not limited to be less than the predetermined value in the second case where the product of the printing resolution and the printing speed is less than the threshold value, it is possible to realize a high quality printing by faithfully reproducing a waveform.

2. It is preferable that the signal modulation section input the reference drive signal and a comparison signal to a voltage comparator to generate the modulation reference drive signal, the comparison signal being configured by a triangular wave or a saw-tooth wave of which frequency varies depending on a voltage of the reference drive signal, and the frequency control section add or substract a clock signal having a frequency less than the predetermined value to or from the reference drive signal before the modulation in the first case, and do not add or substract the clock signal in the second case. In this case, it is possible to avoid the occurrence of problems due to heat generation and increase in power consumption in the first case, and to realize a high quality printing by faithfully reproducing a waveform in the second case, while employing a modulation scheme capable of taking a large variation width of a pulse duty ratio and ensuring a wide output dynamic range.

3. It is preferable that the signal modulation section input the reference drive signal and a comparison signal to a voltage comparator to generate the modulation reference drive signal, the comparison signal being configured by a triangular wave or a saw-tooth wave in which a single waveform is repeated, the frequency control section set a frequency of the comparison signal to be less than the predetermined value in the first case, and set the frequency of the comparison signal to be equal to or greater than the predetermined value in the second case. In this case, it is possible to avoid the occurrence of problems due to heat generation and increase in power consumption in the first case, and to realize a high quality printing by faithfully reproducing a waveform in the second case, while employing a modulation scheme which inputs the reference drive signal and the comparison signal to the voltage comparator to generate the modulation reference drive signal.

4. It is preferable that the signal modulation section generate the modulation reference drive signal by pulsing an amplitude of the reference drive signal at a predetermined sampling frequency, and the frequency control section set the sampling frequency to be less than the predetermined value in the first case, and set the sampling frequency to be equal to or greater than the predetermined value in the second case. In this case, it is possible to avoid the occurrence of problems due to heat generation and increase in power consumption in the first case, and to realize a high quality printing by faithfully reproducing a waveform in the second case, while employing a modulation scheme which generates the modulation reference drive signal by pulsing the amplitude of the reference drive signal.

Further, the invention can be realized in various forms, for example, in forms of a printing method, a liquid ejecting method, a liquid ejecting apparatus, a method of controlling a printing apparatus or a liquid ejecting apparatus, a driving circuit for a printing apparatus or a liquid ejecting apparatus, and the like.

### BRIEF DESCRIPTION OF THE DRAWINGS

The invention will be described with reference to the accompanying drawings, wherein like numbers reference like elements.

FIG. 1 is an explanatory diagram illustrating a schematic configuration of a printing apparatus in an exemplary embodiment of the invention.

FIGS. 2A and 2B are explanatory diagrams illustrating examples of various signals used in a print head.

FIG. 3 is an explanatory diagram illustrating a configuration of a switching controller of the print head.

FIG. 4 is an explanatory diagram illustrating a configuration for generating a drive signal COM in the printing apparatus.

FIG. 5 is an explanatory diagram illustrating an example of a configuration of a signal modulation circuit.

FIG. 6 is an explanatory diagram illustrating an oscillation frequency in the signal modulation circuit.

FIG. 7 is an explanatory diagram illustrating switching aspects of frequency limits.

FIGS. 8A and 8B are explanatory diagrams illustrating examples of a configuration of a signal modulation circuit using a pulse width modulation.

FIG. 9 is an explanatory diagram illustrating an example of a configuration of a signal modulation circuit using a pulse amplitude modulation.

### DESCRIPTION OF EXEMPLARY EMBODIMENTS

### A. Exemplary Embodiment

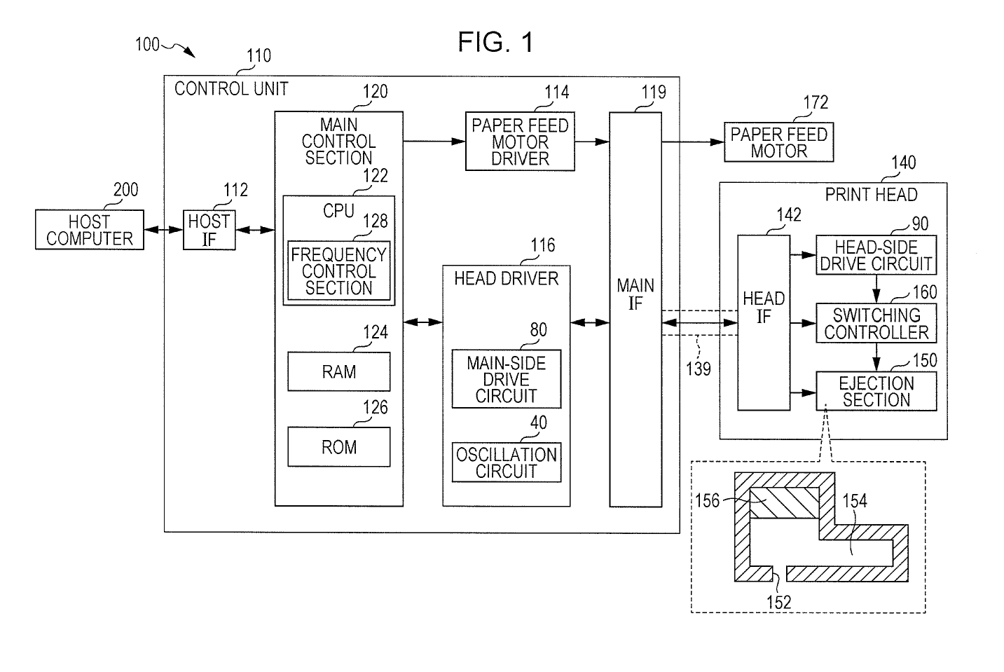

FIG. 1 is an explanatory diagram illustrating a schematic configuration of a printing apparatus 100 in an exemplary embodiment of the invention. The printing apparatus 100 of the present exemplary embodiment is an inkjet printer which ejects liquid ink to form an ink dot group on a print medium, and thus prints images (including characters, graphics, and the like) in response to image data supplied from a host computer 200.

The printing apparatus 100 includes a print head 140, and a control unit 110 connected to the print head 140 through a flexible flat cable 139. The control unit 110 includes a host interface (IF) 112 for inputting image data and the like from a host computer 200, a main control section 120 that performs a predetermined arithmetic processing of printing images on the basis of image data that is input from the host interface 112, a paper feed motor driver 114 which drives and controls a paper feed motor 172 for the transport of the print media, a head driver 116 which drives and controls the print head 140, and a main interface (IF) 119 which connects respective drivers 114, and 116 with the paper feed motor 172 and the print head 140. The head driver 116 includes a main-side drive circuit 80 and an oscillation circuit 40.

The main control section 120 includes a CPU 122 for executing various types of arithmetic processing, a RAM 124 for temporarily storing and developing programs and data, and a ROM 126 for storing programs executed by the CPU 122. The CPU 122 reads the programs, which are stored in the ROM 126, on the RAM 124, and executes the program thereby allowing various functions of the main control section 120 to be realized. For example, the CPU 122 functions as a frequency limiting section 128 which will be described later. In addition, the main control section 120 may include an electrical circuit. The electrical circuit included in the main control section 120 operates on the basis of a configuration of the circuit, thereby allowing at least a part of functions of the main control section 120 to be implemented.

If acquiring image data from the host computer 200 through the host interface 112, the main control section 120 performs an arithmetic processing of performing printing such as an image development processing, a color conversion processing, an ink color separation processing, and a halftone processing on the basis of the image data, so as to generate nozzle selection data (drive signal selection data) for defining which nozzle of the print head 140 the ink is ejected from, or which amount of ink is ejected, and to output control signals to respective drivers 114 and 116 on the basis of the drive signal selection data. In addition, since the content of each arithmetic processing for performing printing that is performed by the main control section 120 is a matter well known in the art of a printing apparatus, the description thereof is omitted here. The respective drivers 114 and 116 output signals for controlling the operation of the paper feed motor 172 and the operation of print head 140, respectively. For example, the head driver 116 supplies the print head 140 with a reference clock signal SCK, a latch signal LAT, a drive signal selection signal SI&SP, and a channel signal CH, which will be described later.

Ink of one or a plurality of colors is supplied to the print head 140 from one or a plurality of ink containers, not shown. The print head 140 includes a head interface (IF) 142, a head-side drive circuit 90, a switching controller 160, and an ejection section 150. The head-side drive circuit 90 and the switching controller 160 operate on the basis of various signals which are input from the control unit 110 through the head interface 142. The ejection section 150 includes a plurality of nozzle opening portions 152 that eject ink, and a plurality of piezoelectric elements 156 provided corresponding to a plurality of nozzle opening portions 152. In the exemplary embodiment, a piezoelectric element is used as the piezoelectric element 156. The nozzle opening portion 152 communicates with a pressure chamber 154 to which ink is supplied. The piezoelectric element 156 varies depending on a drive signal COM (described later) supplied through the head-side drive circuit 90 and the switching controller 160, thereby causing the pressure chamber 154 to be expanded or reduced. If a pressure change occurs in the pressure chamber 154 due to the expansion or the reduction of the pressure chamber 154, the ink is ejected from the corresponding nozzle opening portion 152 due to the pressure change. It is possible to adjust the ejection amount (that is, size of a dot to be formed) of the ink by adjusting the wave height and the slope of voltage increase and decrease of the drive signal COM used to drive the piezoelectric element 156.

The printing apparatus 100 of the present exemplary embodiment is able to perform a printing with at least two printing resolutions which are a first resolution and a second resolution higher than the first resolution, and at least two printing speeds which are a first printing speed and a second printing speed faster than the first printing speed. For example, the selection of the printing resolution and the printing speed is performed on the user interface that is displayed by a printer driver being executed on the host computer 200. The user interface includes a portion for selecting any one of the at least two printing resolutions and a portion for selecting any one of the at least two printing speeds. If a print command including information indicating the printing resolution and the printing speed which are selected on the user interface is sent to the printing apparatus 100 from the host computer 200, the main control section 120 starts a printing with the selected printing resolution and at the selected printing speed. In addition, both the printing speed and the printing resolution may be selected in one selection portion on the user interface. For example, the user interface may include a portion for selecting any one of a plurality of print modes in which combinations of a printing speed and a printing resolution are different from each other (for example, “fast mode” or “fine mode”), and if a print mode is selected, a combination of the printing speed and the printing resolution which are associated with the selected print mode may be selected. For example, when the “fine mode” is selected, a relatively high printing resolution and a relatively slow printing speed are selected, whereas when the “fast mode” is selected, a relatively low printing resolution and a relatively fast printing speed are selected. In addition, the user interface may be displayed on the printing apparatus 100. Further, instead of being selected on the user interface, the print resolution and the print speed may be selected automatically by the host computer 200 or the printing apparatus 100. For example, it may be assumed that the host computer 200 or the printing apparatus 100 determines the type of image to be printed, and selects a combination of the printing speed and the printing resolution which are associated with the determined image type.

In a case where the printing apparatus 100 is a so-called line printer (a printing apparatus which performs a printing by using a head of line type having a plurality of nozzles arranged in a direction intersecting with a transport direction of a print medium, without being involved in a relative movement of the head along the intersecting direction with respect to the print medium), at the time of printing, the print medium is transported by the paper feed motor 172 and ink is ejected from the nozzle opening portion 152 to the print medium. In this case, the paper feed motor 172 has a plurality of operation modes having different transport speeds. If a printing speed and a printing resolution are selected as described above, the paper feed motor driver 114 causes the paper feed motor 172 to operate in the operation mode corresponding to the selected printing speed and printing resolution. For example, when a relatively high printing resolution and a relatively slow printing speed are selected, the paper feed motor 172 operates in a mode in which a transport speed is relatively slow, whereas when a relatively low printing resolution and a relatively fast printing speed are selected, the paper feed motor 172 operates in a mode in which a transport speed is relatively fast. On the other hand, in a case where the printing apparatus 100 is a so-called serial printer (a printing apparatus which performs a printing while performing a transport (sub scanning) of the print medium and a relative movement (main scanning) of the head along a direction intersecting with the transport direction of the print medium with respect to the print medium), at the time of printing, the print medium is transported by the paper feed motor 172, a carriage for mounting the head (not shown) is reciprocated along the intersecting direction (main scanning direction), and ink is ejected from the nozzle opening portion 152 to the print medium. In this case, the paper feed motor 172 has a plurality of operation modes with different transport speeds, and a carriage motor (not shown) for driving the carriage has a plurality of operation modes with different carriage moving speeds. If a printing speed and a printing resolution are selected as described above, the paper feed motor driver 114 causes the paper feed motor 172 to operate in the operation mode corresponding to the selected printing speed and printing resolution, and a carriage motor drive (not shown) for controlling the carriage motor causes the carriage motor to operate in the operation mode corresponding to the selected printing speed and printing resolution. For example, when a relatively high printing resolution and a relatively slow printing speed are selected, the paper feed motor 172 operates in a mode in which a transport speed is relatively slow, and the carriage motor operates in a mode in which a carriage moving speed is relatively slow. Further, when a relatively low printing resolution and a relatively fast printing speed are selected, the paper feed motor 172 operates in a mode in which a transport speed is relatively fast, and the carriage motor operates in a mode in which a carriage moving speed is relatively fast. In addition, only one of the paper feed motor 172 and the carriage motor may have a plurality of operation modes, another one may have a single operation mode. In this case, the motor having a plurality of operation modes operates in an operation mode corresponding to the selected printing speed and printing resolution.

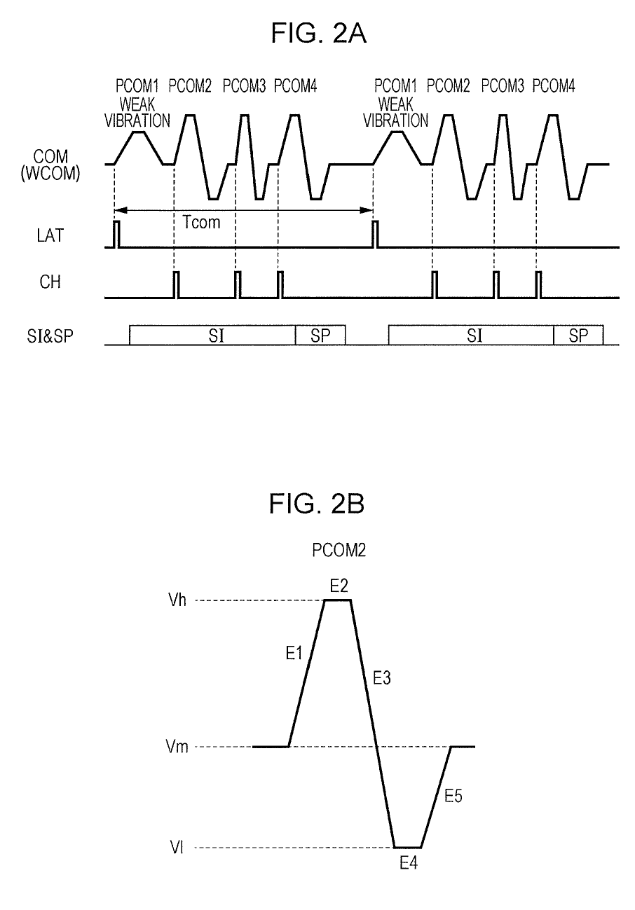

FIGS. 2A and 2B are explanatory diagrams illustrating examples of various signals used in the print head 140. FIG. 2A illustrates examples of a drive signal COM, a latch signal LAT, a channel signal CH, and a drive signal selection signal SI&SP. The drive signal COM is a signal for driving the piezoelectric element 156 provided in the ejection section 150 of the print head 140. The drive signal COM is a signal in which drive pulses PCOMs (drive pulses PCOM1 to PCOM4) as a minimum unit (unit drive signal) of the drive signal for driving the piezoelectric element 156 are continuous in time series. A set of four drive pulses PCOMs, which are drive pulses PCOM1, PCOM2, PCOM3 and PCOM4 that are included in each period Tcom of the drive signal COM, correspond to a pixel (print pixel).

FIG. 2B illustrates an enlarged example of the drive pulse PCOM2. The drive pulse PCOM2 is configured by an expansion portion E1, an expansion holding portion E2, an ejection portion E3, a contraction holding portion E4, and a damping control portion E5. The same is applied even to the drive pulses PCOM3 and PCOM4. The expansion portion E1 of each drive pulse PCOM is a portion for drawing ink (also referred to as drawing a meniscus in consideration of an ink ejection surface) by the volume of the pressure chamber 154 being expanded due to the deformation of the piezoelectric element 156 that is caused by raising an electric potential from an intermediate potential VM corresponding to a normal state of the piezoelectric element 156 to an expansion potential (maximum voltage) Vh. The expansion holding portion E2 is a portion for holding the expansion potential Vh so as to maintain the expanded state of the pressure chamber 154. The ejection portion E3 is a portion (also referred to as pushing a meniscus in consideration of an ink ejection surface) for pushing the ink by the volume of the pressure chamber 154 being contracted due to the deformation of the piezoelectric element 156 that is caused by lowering an electric potential from the expansion potential Vh to a contraction potential (minimum voltage) Vl. The contraction holding portion E4 is a portion for holding the contraction potential Vl so as to maintain the contracted state of the pressure chamber 154. The damping control portion E5 is a portion (also referred to as suppressing the damping of the meniscus in consideration of an ink ejection surface) for returning the volume of the pressure chamber 154 to the normal state by raising the electric potential from the contraction potential Vl to the intermediate potential Vm so as to return the piezoelectric element 156 to the normal state. Depending on each portion of each drive pulse PCOM, the piezoelectric element 156 transits to a normal state, an expansion state for causing the volume of the pressure chamber 154 to expand, an expansion holding state for causing the expanded volume of the pressure chamber 154 to be kept, a contraction state for causing the volume of the pressure chamber 154 to contract, a contraction hold state for causing the contracted volume of the pressure chamber 154 to be kept, and a damping control state for causing the volume of the pressure chamber 154 to return to the normal state, in the order listed. One or a plurality of drive pulses PCOM is selected among drive pulses PCOM2, PCOM3 and PCOM4 and supplied to the piezoelectric element 156, so that it is possible to form ink dots of various sizes. In addition, in the exemplary embodiment, a drive pulse PCOM1 called weak vibration is included in the drive signal COM. The drive pulse PCOM1 is used in a case where the ink is drawn in but is not pushed out, for example, in a case where the thickening of the nozzle opening portions 152 is suppressed. In addition, as will described later, since the drive signal COM is generated by amplifying the reference drive signal WCOM, the signal waveform of the reference drive signal WCOM is the same as the waveform of the drive signal COM illustrated in FIG. 2A.

The drive signal selection signal SI&SP is a signal to select a nozzle opening portion 152 for ejecting the ink and to determine timing at which the piezoelectric element 156 is connected to the drive signal COM. The latch signal LAT and the channel signal CH are signals to connect the drive signal COM to the piezoelectric element 156 of the print head 140, on the basis of the drive signal selection signal SI&SP, after nozzle selection data for all nozzle opening portions 152 is input. As illustrated in FIG. 2A, the latch signal LAT and the channel signal CH are signals which are in synchronous with the drive signal COM. In other words, the latch signal LAT is a signal which becomes a high level in accordance with the start timing of the drive signal COM, and the channel signal CH is a signal which becomes a high level in accordance with the start timing of each drive pulse PCOM constituting the drive signal COM. The outputs of a series of drive signals COM are started in response to the latch signal LAT, and each drive pulse PCOM is output in response to the channel signal CH. Further, a reference clock signal SCK is a signal for transferring the drive signal selection signal SI&SP as a serial signal to the print head 140. In other words, the reference clock signal SCK is a signal used to determine timing at which ink is ejected from the nozzle opening portion 152 of the print head 140.

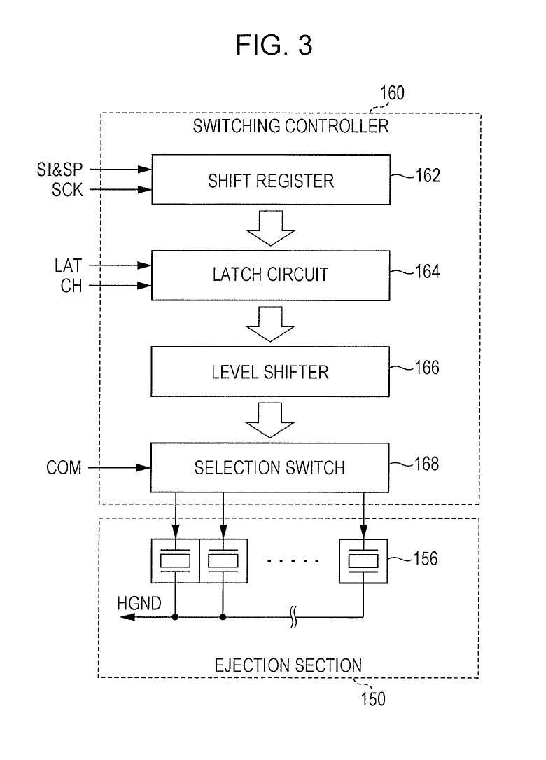

FIG. 3 is an explanatory diagram illustrating a configuration of a switching controller 160 (see FIG. 1) of the print head 140. The switching controller 160 selectively supplies the drive signal COM to the piezoelectric element 156. The switching controller 160 includes a shift register 162 that saves the drive signal selection signal SI&SP, a latch circuit 164 that temporarily saves data of the shift register 162, a level shifter 166 that level-converts the output of the latch circuit 164 and supplies the changed output to a selection switch 168, and the selection switch 168 that connects the drive signal COM to the piezoelectric element 156.

The drive signal selection signal SI&SP is sequentially input to the shift register 162, and thus a region, to which data is stored, is sequentially shifted to the subsequent stage in response to the input pulse of the reference clock signal SCK. After the drive signal selection signals SI&SP of the number of nozzles are stored in the shift register 162, the latch circuit 164 latches each output signal of the shift register 162 in response to the latch signal LAT to be input. The signal saved in the latch circuit 164 is converted to a voltage level, at which the selection switch 168 of the subsequent stage can be switched (ON/OFF), by the level shifter 166. The piezoelectric element 156 corresponding to the selection switch 168 to be closed (becomes a connection state) by the output signal of the level shifter 166 is connected to the drive signal COM (drive pulses PCOM) at the connection timing of the drive signal selection signal SI&SP. Thus, the piezoelectric element 156 is changed, and the ink of the amount in response to the drive signal COM is ejected from the nozzle. Further, after the drive signal selection signal SI&SP which is input to the shift register 162 is latched to the latch circuit 164, a subsequent drive signal selection signal SI&SP is input to the shift register 162 and data saved in the latch circuit 164 is sequentially updated in accordance with the ejection timing of the ink. According to the selection switch 168, even after the piezoelectric element 156 is separated from the drive signal COM (drive pulse PCOM), an input voltage of the piezoelectric element 156 is maintained at the voltage immediately before the separation. In addition, a symbol HGND in FIG. 3 denotes a ground end of the piezoelectric element 156.

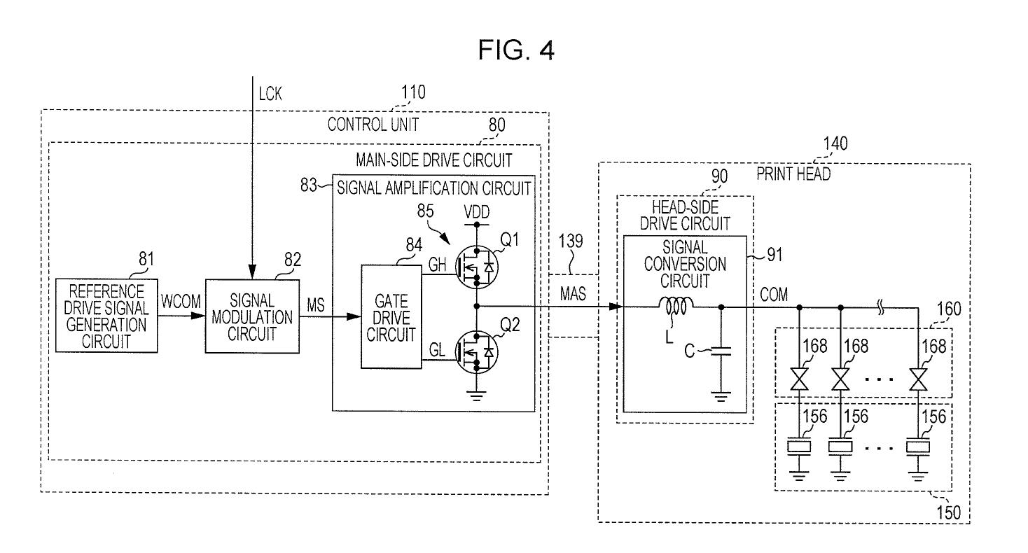

FIG. 4 is an explanatory diagram illustrating a configuration for generating a drive signal COM in the printing apparatus 100. In FIG. 4, with respect to the configurations which are not directly related to the generation of the drive signal COM out of the configurations of the printing apparatus 100, the illustration thereof are appropriately omitted. In the exemplary embodiment, the drive signal COM is generated by the main-side drive circuit 80 of the control unit 110 and the head-side drive circuit 90 of the print head 140. The main-side drive circuit 80 includes a reference drive signal generation circuit 81, a signal modulation circuit 82, and a signal amplification circuit 83. Further, the head-side drive circuit 90 includes a signal conversion circuit 91.

The reference drive signal generation circuit 81 is a circuit which generates an analog reference drive signal WCOM as a reference of the aforementioned drive signal COM. For example, as described in JP-A-2011-207234, the reference drive signal generation circuit 81 is configured to include a waveform memory for storing waveform forming data, which is input from the main control section 120, in a storage element corresponding to a predetermined address, a first latch circuit which latches the waveform forming data read from the waveform memory by a first clock signal, an adder which adds an output of the first latch circuit and waveform forming data W to be output from a second latch circuit that will be described later, a second latch circuit which latches an addition output of the adder by a second clock signal, and a D/A converter which converts the waveform forming data to be output from the second latch circuit to the reference drive signal WCOM that is an analog signal.

The signal modulation circuit 82 is a circuit which receives reference drive signal WCOM from the reference drive signal generation circuit 81, and generates a modulation reference drive signal MS which is a digital signal by performing a pulse modulation on the reference drive signal WCOM. The signal modulation circuit 82 will be described later.

The signal amplification circuit 83 is a circuit (a so called D-class amplifier) which receives a modulation reference drive signal MS from the signal modulation circuit 82, and generates a modulation drive signal MAS by performing power amplification on the modulation reference drive signal MS. The signal amplification circuit 83 includes a half-bridge output stage 85 configured by two switching elements (a high-side switching element Q1 and a low-side switching element Q2) for substantially amplifying the power, and a gate drive circuit 84 which adjusts respective gate-source signals GH and GL of the switching elements Q1 and Q2, on the basis of the modulation reference drive signal MS from the signal modulation circuit 82. In the signal amplification circuit 83, when the modulation reference drive signal MS is high level, the gate-source signal GH becomes high level and thus the high-side switching element Q1 turns ON, but the gate-source signal GL becomes low level and thus the low-side switching element Q2 turns OFF. As a result, the output of the half-bridge output stage 85 becomes a supply voltage VDD. On the other hand, when the modulation reference drive signal MS is low level, the gate-source signal GH becomes low level, and thus high-side switching element Q1 turns OFF, but the gate-source signal GL becomes high level and thus the low-side switching element Q2 turns ON. As a result, the output of the half-bridge output stage 85 becomes zero. In this way, the signal amplification circuit 83 performs power amplification by switching operations of the high-side switching element Q1 and the low-side switching element Q2 on the basis of the modulation reference drive signal MS, and thus the modulation drive signal MAS is generated. In addition, the switching frequency of each of the switching elements Q1 and Q2 is equal to the frequency of the modulation reference drive signal MS which is input from the signal modulation circuit 82, that is, the oscillation frequency of the signal modulation circuit 82, by the aforementioned operation.

The signal conversion circuit 91 is a circuit (a so-called smoothing filter) which receives the modulation drive signal MAS from the signal amplification circuit 83, and generates the drive signal COM (drive pulse PCOM) which is an analog signal by smoothing the modulation drive signal MAS. In the exemplary embodiment, a low pass filter using a combination of a capacitor C and a coil L is used as the signal conversion circuit 91. The signal conversion circuit 91 attenuates modulation frequency components generated in the signal modulation circuit 82, and outputs the drive signal COM having a waveform characteristic described above. The drive signal COM generated by the signal conversion circuit 91 is supplied to the piezoelectric element 156 of the ejection section 150 through the selection switch 168 of the switching controller 160.

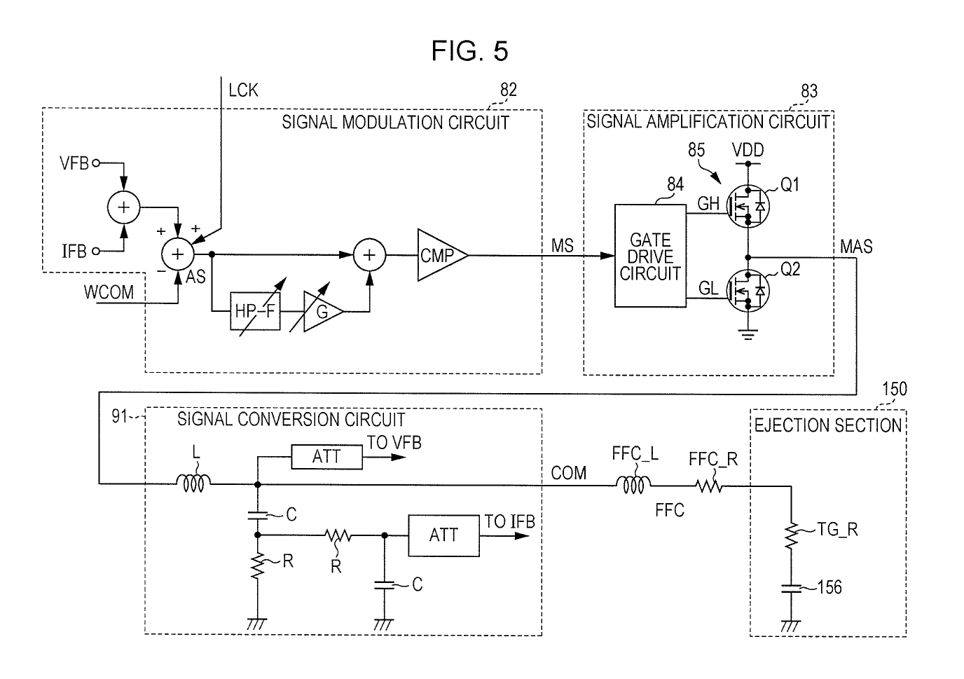

FIG. 5 is an explanatory diagram illustrating an example of a detailed configuration of a drive circuit. A pulse density modulation (PDM) of a self-excited type is used as a modulation method in the signal modulation circuit 82 in the exemplary embodiment. As illustrated in FIG. 5, the signal modulation circuit 82 inputs a reference drive signal WCOM and a comparison signal configured by a triangular wave or a saw- tooth wave of which the frequency changes according to the voltage of the reference drive signal WCOM to the voltage comparator so as to generate the modulation reference drive signal MS. In general, the pulse density modulation is performed by using a so-called ΔΣ modulation circuit which includes a comparator that compares the input signal with a predetermined value and outputs a signal that becomes a high level when the input signal is the predetermined value or more, a subtractor that calculates an error between the input signal and the output signal of the comparator, a delay device that delays the error, and an adder-subtractor that adds or subtracts the delayed error to or from the original signal. However, in the example illustrated in FIG. 5, the signal modulation circuit 82 using pulse density modulation does not include the delay device. A low-pass filter that is configured as the signal conversion circuit 91 is also referred to as a delay device, so that as denoted as VFB in FIG. 5, an output (COM) of a LC low pass filter instead of the delay device is used as a delay signal. Further, a circuit (high pass filter (HP-F) and high-frequency boost (G)) which emphasizes high-frequency components and a circuit (denoted as “IFB”) which returns the high-frequency components are added in the present exemplary embodiment. In other words, in this example, the signal modulation circuit 82 receives a modulation signal after amplification by the signal amplification circuit 83 as a return signal, and corrects the modulation reference drive signal MS to be generated. In addition, the signal modulation circuit 82 includes a circuit using the ΔΣ modulation circuit, but it may be configured using another circuit capable of performing a pulse density modulation.

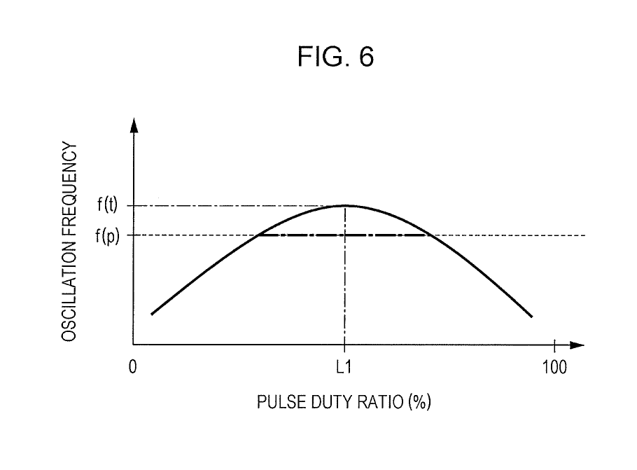

The modulation method in the modulation circuit 82 in the present exemplary embodiment is a self-excited oscillation type pulse density modulation method, and the oscillation frequency varies depending on a signal level (pulse duty ratio) of the drive waveform signal WCOM to be input. FIG. 6 is an explanatory diagram illustrating an oscillation frequency in the signal modulation circuit 82. In the pulse density modulation method, the oscillation frequency becomes the highest (maximum value f(t)) when an input signal level is an intermediate value L1, and it becomes low as the input signal level becomes smaller or larger than the intermediate value L1, as indicated as a solid line in FIG. 6. The pulse duty ratio in the vicinity of the intermediate value is about 50%, but the pulse duty ratio varies with the decrease of the oscillation frequency. Compared with the pulse width modulation with the fixed modulation frequency, this method has an advantage that it is possible to take a large change width of the pulse duty ratio and to ensure a wide output dynamic range. That is, since a minimum value of a negative pulse width and a positive pulse width that can be handled by the whole modulation circuit is limited in the circuit characteristics, the pulse signal less than the minimum value disappears prematurely. Therefore, it is possible to ensure only a pulse duty ratio change width within a predetermined range (for example, 10% to 90%) in the pulse width modulation method with the fixed modulation frequency. In contrast, as the input signal level becomes larger or smaller than the intermediate value in the self-excited oscillation type pulse density modulation method of the present exemplary embodiment, the oscillation frequency becomes low, so that it is possible to handle a signal having a larger pulse duty in a part in which an input signal level is very large, and to handle a signal having a smaller pulse duty in a part in which an input signal level is very small. Therefore, it is possible to ensure a pulse duty ratio change width of a wider range (for example, 5% to 95%). A specific example will be illustrated below. For example, if it is assumed that both the positive and negative minimum pulse width that can be handled by the entire circuit is 25 ns, when the modulation frequency is fixed to 4 MHz, the pulse duty ratio change width is determined by the ratio to the cycle, so that it is possible to ensure only a pulse duty ratio change width of 10% to 90%. In the self-excited oscillation type pulse density modulation method of the present exemplary embodiment, if the oscillation frequency varies depending on the input signal level, for example, it becomes 2 MHz when the input signal is low level and high level, it is possible to ensure a pulse duty ratio change width of 5% to 95%. Thus, it is possible to ensure a wide output dynamic range. Further, since the self-excited oscillation type pulse density modulation method of the present exemplary embodiment does not need to include a circuit which generates a high-frequency signal to an outside as an externally excited modulation method with a fixed frequency, there is an advantage of a system configuration that it is relatively easily made into one chip.

Here, in a predetermined case which will be described later, a frequency limiting section 128 (FIG. 1) causes an oscillation circuit 40 to supply a frequency limit clock signal LCK to the signal modulation circuit 82. If the frequency limit clock signal LCK is input to the signal modulation circuit 82 (FIG. 4), the frequency limit clock signal LCK is input to an adder-subtractor AS in the modulation circuit 82 (FIG. 5). The frequency limit clock signal LCK which is input is added to or subtracted from the drive waveform signal WCOM by the adder-subtractor AS. In the state in which the frequency limit clock signal LCK is input to the signal modulation circuit 82, the oscillation frequency in the modulation circuit 82 is limited to the frequency of the frequency limit clock signal LCK. That is, if the oscillation frequency of the signal modulation circuit 82 approaches the frequency limit clock signal LCK, the oscillation frequency is drawn into the frequency limit clock signal LCK and fixed to the frequency f(p) of the frequency limit clock signal LCK (see the broken line in FIG. 6). If an input signal level changes and the original oscillation frequency deviates greatly from the frequency f(p) of the frequency limit clock signal LCK, fixing to the frequency limit clock signal LCK is released, and the oscillation frequency of the modulation circuit 82 returns to a normal oscillation frequency corresponding to the input signal level. In this manner, the frequency limiting section 128 switches as to whether or not to supply the frequency limit clock signal LCK to the signal modulation circuit 82 from the oscillation circuit 40, thereby switching as to whether or not to limit the oscillation frequency in the modulation circuit 82 to be less than the frequency f(p) of the frequency limit clock signal LCK. As described above, since the oscillation frequency in the modulation circuit 82 is equal to the switching frequency of each of the switching elements Q1 and Q2 of the signal amplification circuit 83, it may be expressed that the frequency limiting section 128 can switch as to whether or not to limit the switching frequency of each of the switching elements Q1 and Q2 to be less than a predetermined value.

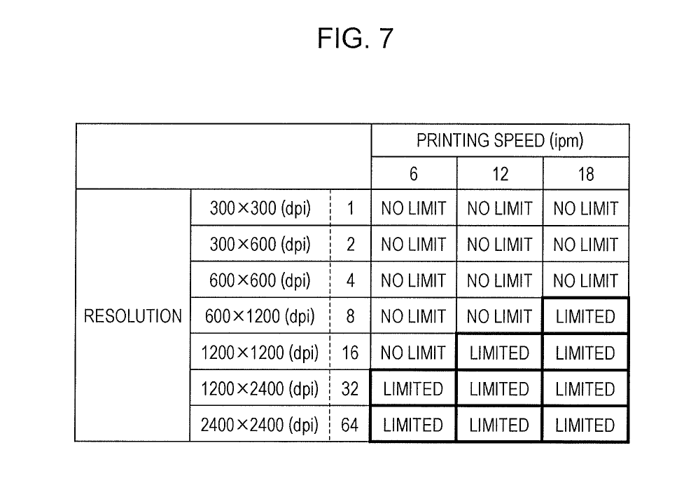

FIG. 7 is an explanatory diagram illustrating switching aspects of frequency limits. As illustrated in FIG. 7, the printing apparatus 100 of the present exemplary embodiment may select one of three speeds (6, 12, 18 ipm (image per minute)) as the printing speed, and may select one of six resolutions (300×300 dpi (dot per inch) to 2400×2400 dpi) as the printing resolution. The numbers in the right column next to the printing resolution denotes a ratio obtained when the lowest resolution (300×300 dpi) is set to the reference value 1.

In the present exemplary embodiment, in a first case where a product of the printing speed and the printing resolution (more specifically, the value of the ratio, hereinafter the same) is equal to or greater than a predetermined threshold value, the frequency limiting section 128 limits the switching frequency of each of the switching elements Q1 and Q2, and in a second case where a product of the printing speed and the printing resolution is less than the predetermined threshold value, the frequency limiting section 128 does not limit the switching frequency of each of the switching elements Q1 and Q2. For example, the threshold value is set to 100. As illustrated in FIG. 7, in a case where the printing speed is 6 ipm and the printing resolution is 1200×1200 dpi, the product is 96, so that the frequency limiting section 128 does not limit the switching frequency. On the other hand, in a case where the printing speed is 6 ipm and the printing resolution is 1200×2400 dpi, the product is 192, so that the frequency limiting section 128 limits the switching frequency.

If the printing speed is fast or the printing resolution is high, the number of switching times per unit time of each of the switching elements Q1 and Q2 of the signal amplification circuit 83 is increased, so that there is a concern that problems due to heat generation and increase in power consumption occur. Since in the printing apparatus 100 of the present exemplary embodiment, in the first case where the product of the printing speed and the printing resolution is equal to or greater than the predetermined threshold value, the frequency limiting section 128 limits the switching frequency of each of the switching elements Q1 and Q2, it is possible to avoid the occurrence of problems due to heat generation and increase in power consumption. In this case, although waveform reproducibility is impaired and thus there is a little impact on the quality, the frequency limit is carried out in only the portion in which the pulse duty ratio is the intermediate-level (FIG. 6), so that it is possible to suppress as much as possible the impact on the image quality. Further, in the printing apparatus 100 of the present exemplary embodiment, in the second case where the product of the printing speed and the printing resolution is less than the predetermined threshold value, the frequency limiting section 128 does not limit the switching frequency of each of the switching elements Q1 and Q2, it is possible to realize a high-quality printing with faithful waveform reproduction.

### B. Modification Example

In addition, the invention is not limited to the exemplary embodiment, the invention can be implemented in various embodiments without departing from the scope and spirit thereof, and for example, the following modifications are also possible.

### B1. Modification Example 1

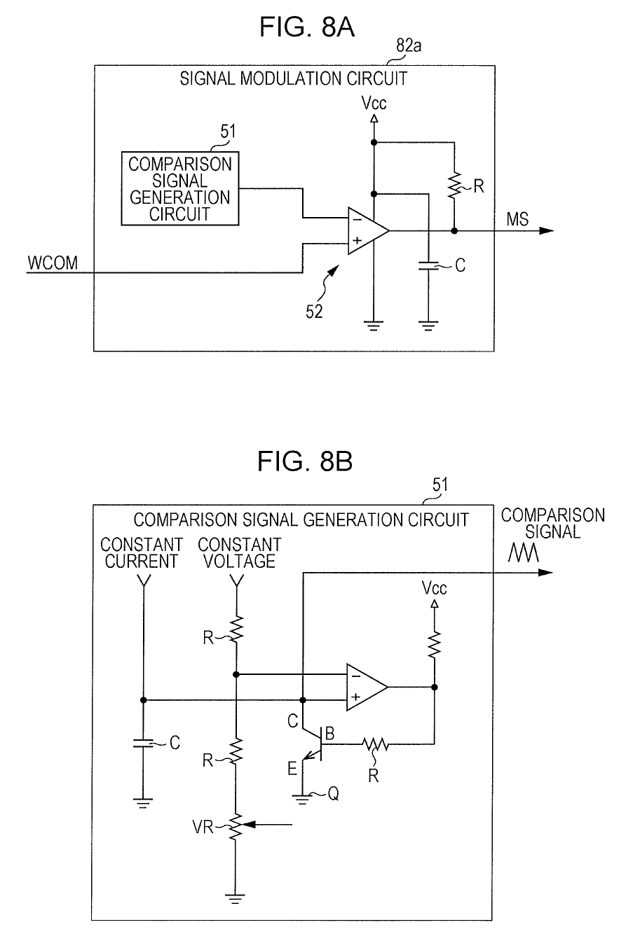

The configuration of the printing apparatus 100 in the above exemplary embodiment is merely an example, and various variations are possible. For example, a pulse density modulation (PDM) is used as a modulation method in the signal modulation circuit 82 in the exemplary embodiment, but instead thereof, a pulse width modulation (PWM) may be used. FIGS. 8A and 8B are explanatory diagrams illustrating an example of a configuration of a signal modulation circuit 82a using a pulse width modulation. As illustrated in FIG. 8A, the signal modulation circuit 82a includes a comparison signal generation circuit 51 that outputs a comparison signal configured by a triangular wave (or saw-tooth wave) in which a single waveform is repeated at a predetermined frequency and a voltage comparator 52 that compares a reference drive signal WCOM with the comparison signal. FIG. 8B illustrates an example of a configuration of the comparison signal generation circuit 51. According to the signal modulation circuit 82a, a modulation reference drive signal MS is generated which is Hi when the reference drive signal WCOM is the comparison signal or more, and is Lo when the reference drive signal WCOM is less than the comparison signal. In other words, the frequency of the modulation reference drive signal MS is equal to the frequency of the comparison signal. In the modification example, the frequency limiting section 128 (FIG. 1) can change the frequency of the modulation reference drive signal MS (that is, the switching frequency of each of the switching elements Q1 and Q2) by changing the frequency of the comparison signal. In the modification example, in the first case where the product of the printing speed and the printing resolution is equal to or greater than the predetermined threshold value, the frequency limiting section 128 sets the frequency of the comparison signal to be less than the predetermined value. Therefore, the switching frequency of each of the switching elements Q1 and Q2 is limited to be less than the predetermined value, and thus it is possible to avoid the occurrence of problems due to heat generation and increase in power consumption. In the second case where the product of the printing speed and the printing resolution is less than the predetermined threshold value, the frequency limiting section 128 sets the frequency of the comparison signal to be equal to or greater than the predetermined value. Therefore, the switching frequency of each of the switching elements Q1 and Q2 is not limited to be less than the predetermined value, and thus it is possible to realize a high-quality printing with faithful waveform reproduction.

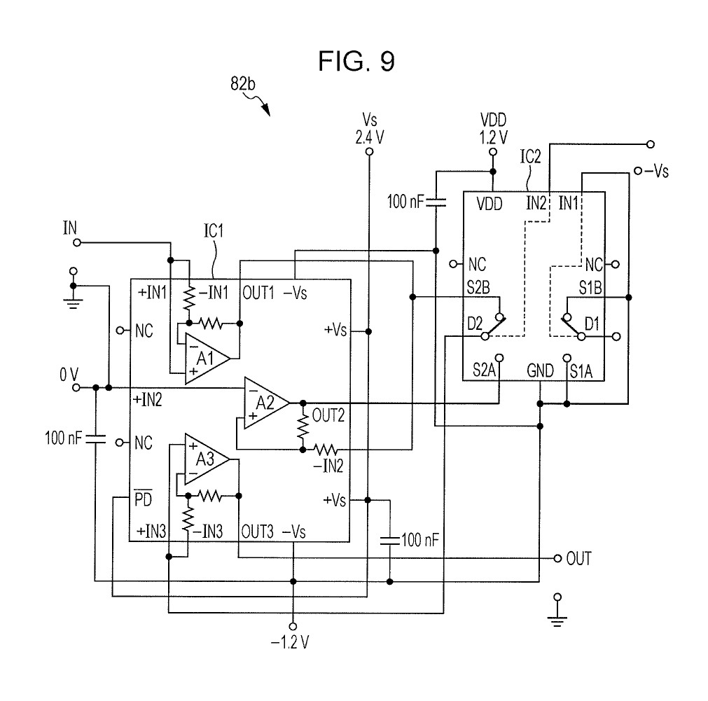

Further, a pulse amplitude modulation (PAM) may be used as a modulation method in the signal modulation circuit 82. FIG. 9 is an explanatory diagram illustrating an example of a configuration of a signal modulation circuit 82b using a pulse amplitude modulation. As illustrated in FIG. 9, the signal modulation circuit 82b generates the modulation reference drive signal MS by pulsing the amplitude of reference drive signal WCOM at a predetermined sampling frequency. Specifically, the signal modulation circuit 82b illustrated in FIG. 9 is configured using a video amplifier IC1 (for example, “ADA4856-3” manufactured by Analog Devices, Inc., U.S.) having three operational amplifiers (A1, A2, and A3). Two resistors are respectively connected to each of the operational amplifier A1, A2 and A3. By the illustrated wirings, the operational amplifiers A1 and A3 function as forward amplifiers of which gain (amplification degree) is 1, and the operational amplifier A2 functions as a reward amplifier of which gain is −1. IC2 is a high-speed multiplexer of Break-Before-Make (BBM) type (for example, “ADG772” manufactured by Analog Devices, Inc., U.S.), and alternately switches a destination of a connection to the input of the operational amplifier A3 between the output of the operational amplifier A1 and the output of the operational amplifier A2. The duty cycle of a control logic signal IN2 of the IC2 is maintained close to 50%. Thus, the average value of the output voltage of the operational amplifier A3 becomes about 0 V.

For example, when the modulation rate, that is, the frequency of the control logic signal is about 6 MHz, the direct current component of the output voltage is only low-frequency offset voltage of an average of only 4 mV or less. Typically, both contacts S2A and S2B of the switch temporarily turn off in Break-Before-Make Time Delay (tBBM) of 5 ns. When the control frequency is 60 MHz, the period while each switch turns on is supposed to be about 8.3 ns, one half period, but actually the period while each switch turns on becomes 3.3 ns because tBBM exists. Further, if the turn-on times of the contacts S2A and S2B of the switch are different, it appears as a direct current component in the result. According to the circuit illustrated in FIG. 9, the reference drive signal WCOM is input to the input terminal IN and the modulation reference drive signal MS is generated as a pulse amplitude modulation wave in which the absolute value of the amplitude of each pulse is equal to the instantaneous voltage level of the waveform of the reference drive signal WCOM and the signal is alternately changed to positive and negative. Since the waveform of the generated modulation reference drive signal MS has an average value of about 0 V, it can be easily transferred in a state being insulated by the transformer. In addition, another multiplexer which performs an operation of Make-Before-Break (MBB) type may be used as the multiplexer used in the circuit of FIG. 9. In such a type of multiplexer, a conduction period at the frequency of 60 MHz is equal to or greater than three times the conduction period in the above case, the impact resulted from the difference in the turn-on times between the switches is also reduced. In addition, in a case of using the MBB type multiplexer, it is necessary to prevent the overload caused by short circuit outputs of the operational amplifiers A1 and A2 from occurring, so that it is preferable to insert a surface mount resistor (for example, substantially 20 Ω) in the outputs of the operational amplifiers A1 and A2. In addition, the signal modulation circuit 82b may be configured using another circuit capable of performing a pulse amplitude modulation.

In the modification example illustrated in FIG. 9, the frequency of the modulation reference drive signal MS is equal to the sampling frequency. In the modification example, the frequency limiting section 128 (FIG. 1) can change the frequency of the modulation reference drive signal MS (that is, the switching frequency of each of the switching elements Q1 and Q2) by changing the sampling frequency. In the modification example, in the first case where the product of the printing speed and the printing resolution is equal to or greater than the predetermined threshold value, the frequency limiting section 128 sets the sampling frequency to be less than the predetermined value. Therefore, the switching frequency of each of the switching elements Q1 and Q2 is limited to be less than the predetermined value, and thus it is possible to avoid the occurrence of problems due to heat generation and increase in power consumption. In the second case where the product of the printing speed and the printing resolution is less than the predetermined threshold value, the frequency limiting section 128 sets the sampling frequency to be equal to or greater than the predetermined value. Therefore, the switching frequency of each of the switching elements Q1 and Q2 is not limited to be less than the predetermined value, and thus it is possible to realize a high-quality printing with faithful waveform reproduction.

### B2. Modification Example 2

The selection examples (FIG. 7) of the printing speed and the printing resolution in the above exemplary embodiment are only examples, and various modifications may be made. For example, the number of choices of the printing speed may be two, or may be four or more. Similarly, the number of choices of the printing resolution may be 2, 3, 4, 5, or 6, or may be eight or more. Although it is determined whether to perform the frequency limit based on whether the product of the printing speed and the printing resolution is less than the threshold value in the above exemplary embodiment, the units of the printing speed and the printing resolution at the time of calculating the product may be changed arbitrarily. An appropriate threshold value may be set depending on the units of the printing speed and the printing resolution. In addition, the threshold value may be selected from among a plurality of choices.

### B3. Modification Example 3

Further, various signals that were exemplified in the above exemplary embodiment are merely examples, and various modifications are possible. For example, although the drive signal COM is a signal that is configured by a plurality of trapezoidal waveforms in the exemplary embodiment, the drive signal COM may be a signal that is configured by a plurality of rectangular waveforms, and may be a signal including curved waveforms.

Further, although the signal amplification circuit 83 is disposed within the main-side drive circuit 80 of the control unit 110 in the exemplary embodiment, the signal amplification circuit 83 may be disposed within the head-side drive circuit 90 of the print head 140. Further, although the signal conversion circuit 91 is disposed within the head-side drive circuit 90 of the print head 140 in the exemplary embodiment, the signal conversion circuit 91 may be disposed on the flexible flat cable 139 that connects the control unit 110 and the print head 140.

In addition, although the printing apparatus 100 receives image data from the host computer 200 to perform a printing process in the exemplary embodiment, instead thereof, the printing apparatus 100 may perform the printing process on the basis of, for example, image data acquired from a memory card, image data acquired from a digital camera through a predetermined interface, image data acquired by a scanner, and the like. Further, the main control section 120 of the printing apparatus 100 which receives image data performs an arithmetic processing of performing printing such as an image development processing, a color conversion processing, an ink color separation processing, and a halftone processing in the exemplary embodiment, but the arithmetic processing may be performed by the host computer 200. In this case, the printing apparatus 100 receives a print command generated using the arithmetic processing by the host computer 200, and performs a print processing according to the print command Further, the invention is applicable to a serial printer in which a carriage for mounting the print head 140 is reciprocated during printing, and is also applicable to a line printer without being involved in such reciprocation. Further, the invention is also applicable to an on-carriage type printer in which an ink cartridge is reciprocated along with a carriage, and is also applicable to an off-carriage type printer in which the holder for mounting an ink cartridge is provided in a location other than a carriage, and ink is supplied from the ink cartridge to a print head 140 through a flexible tube or the like. Further, the invention is also applicable to a printing apparatus which forms an image on print media with a liquid (including the fluid-like material such as a liquid body or a gel in which particles of functional materials are dispersed) other than ink.

Further, a part of the configuration realized by hardware in the exemplary embodiment may be replaced by software, on the contrary, a part of the configuration realized by software in the exemplary embodiment may be replaced by hardware. Further, in a case where all or a part of functions of the invention is realized by software, the software (computer program) can be provided in a form stored on a computer readable recording medium. In the invention, “computer readable recording medium” is not limited to a portable recording medium such as a flexible disk and a CD-ROM, but includes an internal storage device, installed in a computer, such as various ROMs and RAMs, and an external storage device, fixed to the computer, such as a hard disk, or the like.

The entire disclosure of Japanese Patent Application No. 2012-224649, filed Oct. 10, 2012 is expressly incorporated by reference herein.

What is claimed is:

1. A printing apparatus capable of performing a printing with at least two printing resolutions which are a first resolution and a second resolution higher than the first resolution, and at least two printing speeds which are a first printing speed and a second printing speed faster than the first printing speed, comprising:
a reference drive signal generation section that generates a reference drive signal;
a signal modulation section that modulates the reference drive signal to generate a modulation reference drive signal;
a signal amplification section that amplifies the modulation reference drive signal using switching elements to generate a modulation drive signal;
a signal conversion section that converts the modulation drive signal to a drive signal;
a piezoelectric element that deforms in response to the drive signal;
a pressure chamber that expands or contracts due to the deformation of the piezoelectric element;
a nozzle opening portion that communicates with the pressure chamber; and
a frequency control section which limits a switching frequency of the switching element to be less than a predetermined value in a first case where a product of the printing resolution and the printing speed is equal to or larger than a threshold value, and does not limit a switching frequency of the switching element to be less than a predetermined value in a second case where a product of the printing resolution and the printing speed is less than a threshold value.

2. The printing apparatus according to claim 1,
wherein the signal modulation section inputs the reference drive signal and a comparison signal to a voltage comparator to generate the modulation reference drive signal, the comparison signal being configured by a triangular wave or a saw-tooth wave of which frequency varies depending on a voltage of the reference drive signal, and
wherein the frequency control section adds or substracts a clock signal having a frequency less than the predetermined value to or from the reference drive signal before the modulation in the first case, and does not add or substract the clock signal in the second case.

3. The printing apparatus according to claim 1,
wherein the signal modulation section inputs the reference drive signal and a comparison signal to a voltage comparator to generate the modulation reference drive signal, the comparison signal being configured by a triangular wave or a saw-tooth wave in which a single waveform is repeated, and
wherein the frequency control section sets a frequency of the comparison signal to be less than the predetermined value in the first case, and sets the frequency of the comparison signal to be equal to or greater than the predetermined value in the second case.

4. The printing apparatus according to claim 1,
wherein the signal modulation section generates the modulation reference drive signal by pulsing an amplitude of the reference drive signal at a predetermined sampling frequency, and
wherein the frequency control section sets the sampling frequency to be less than the predetermined value in the first case, and sets the sampling frequency to be equal to or greater than the predetermined value in the second case.

5. A printing method capable of performing a printing with one of at least two printing resolutions which are a first resolution and a second resolution higher than the first resolution, and at one of at least two printing speeds which are a first printing speed and a second printing speed faster than the first printing speed, comprising:
generating a reference drive signal;
modulating the reference drive signal to generate a modulation reference drive signal;
amplifying the modulation reference drive signal using switching elements to generate a modulation drive signal;
converting the modulation drive signal to a drive signal;
causing deformation of a piezoelectric element in response to the drive signal, and ejecting a liquid from a nozzle opening portion that communicates with a pressure chamber that expands or contracts due to the deformation of the piezoelectric element, and
limiting a switching frequency of the switching element to be less than a predetermined value in a first case where a product of the printing resolution and the printing speed is equal to or larger than a threshold value, and not limiting a switching frequency of the switching element to be less than a predetermined value in a second case where a product of the printing resolution and the printing speed is less than a threshold value.
